(19) United States
(12) Patent Application Publication
(10) Pub. No.: US 2017/0341700 A1
(43) Pub. Date: Nov. 30, 2017

(54) INTEGRATED E-BIKE AXLE LOCKING SYSTEM

(71) Applicant: GM Global Technology Operations LLC, Detroit, MI (US)

(72) Inventors: Lawrence G. COLE, Utica, MI (US); Richard J. LANNEN, Royal Oak, MI (US); Wade W. BRYANT, Grosse Pointe Farms, MI (US); Jess R. BAILIE, Shelby Township, MI (US); Miranda P. STEINHAUSER, Royal Oak, MI (US)

(21) Appl. No.: 15/165,306

(22) Filed: May 26, 2016

(51) Int. Cl. B62K 19/30; B62K 15/00

(52) U.S. Cl. CPC B62K 19/30; B62K 15/006

(57) ABSTRACT

A product that may include a first axle assembly that may have a lock shaft extendable from the first axle assembly. The lock shaft may be retractable into the first axle assembly. A second axle assembly may have a lock receiver into which the lock shaft may extend when the first and second axle assemblies may be aligned adjacent to one another

### TECHNICAL FIELD

The field to which the disclosure generally relates includes cycles, and more particularly, includes cycles with folding features.

### BACKGROUND

Cycles may come in a variety of forms that may be propelled through manual power, machine power, or both. Reconfiguring a cycle to a compact form may be desirable for storage or transportation. New approaches to enable and support reconfiguration are needed.

### SUMMARY OF ILLUSTRATIVE VARIATIONS

A number of illustrative variations may involve a product that may include a first axle assembly that may have a lock shaft extendable from the first axle assembly. The lock shaft may be retractable into the first axle assembly. A second axle assembly may have a lock receiver into which the lock shaft may extend when the first and second axle assemblies may be aligned adjacent to one another.

A number of additional illustrative variations may involve a product that may include a first wheel that may be rotatable on a first axle assembly. A second wheel may be rotatable on a second axle assembly. A lock shaft may be extendable from the first axle assembly and may be retractable into the first axle assembly. A second axle assembly may have a lock receiver into which the lock shaft may extend to lock the first and second axle assemblies in alignment.

Other illustrative variations within the scope of the invention will become apparent from the detailed description provided herein. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a cycle in an unfolded position according to a number of variations.

FIG. 2 illustrates a cycle in a folded position according to a number of variations.

FIG. 3 illustrates a part of a product in a lock system engaged position according to a number of variations.

FIG. 4 illustrates a part of a product during an automatic lock system engagement state according to a number of variations.

FIG. 5 illustrates an axle assembly part of a product according to a number of variations.

FIG. 6 illustrates a part of a product in a lock system released position according to a number of variations.

FIG. 7 illustrates a part of a product showing a cam release engaged with a cam lock in a lock system released position according to a number of variations.

FIG. 8 illustrates an axle assembly part of a product according to a number of variations.

FIG. 9 illustrates an axle assembly part of a product according to a number of variations.

### DETAILED DESCRIPTION OF ILLUSTRATIVE VARIATIONS

The following description of the variations is merely illustrative in nature and is in no way intended to limit the scope of the invention, its application, or uses.

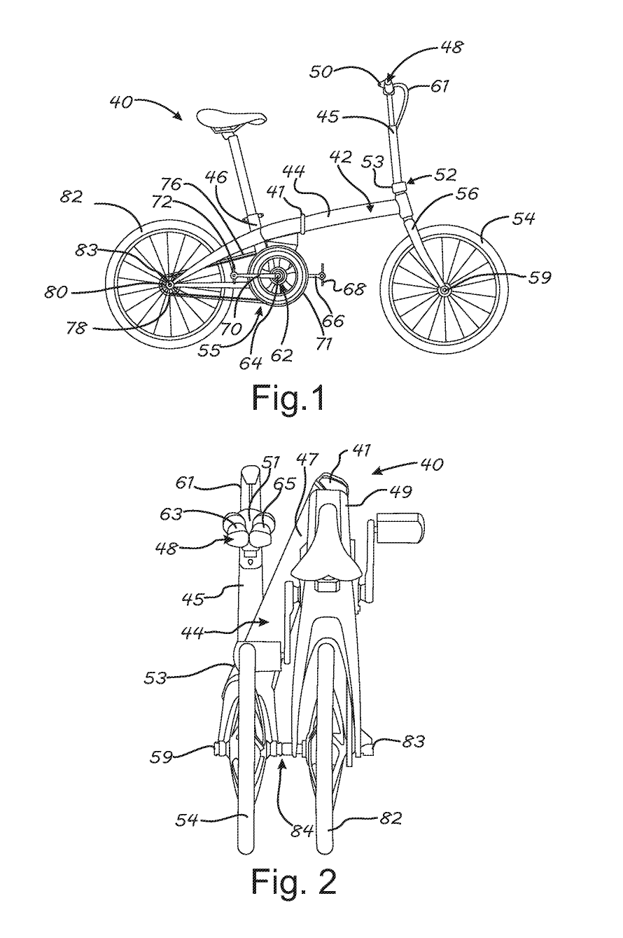

FIG. 1 illustrates a number of variations which may include a cycle 40. In any of a number of variations, the cycle 40 may include a frame 42 which may include a main tube 44 connected to a seat tube 46. The main tube 44 may include a hinged joint 41 to enable folding the frame 42, so that the cycle 40 may be more easily transported and stored. A latch release may unlatch the joint 41. Additional joints may be included to facilitate folding of the frame 42 into a reduced package size for storage or transport. A steering tube 45 may extend from the main tube 44. The steering tube 45 may be operatively connected to a front fork 56 which may be attached to a front wheel 54. A handlebar assembly 48 may be attached to the steering tube 45 and may be used to control the direction of the front wheel 54 by way of the front fork 56. The front fork 56 may be connected with the front wheel 54 at an axle assembly 59. The handlebar assembly 48 may include a pair of opposed handles, and may include a joint to enable folding of the handlebar assembly 48. A handle 61, separate from the pair of opposed handles of the handlebar assembly 48 may be included on the steering tube 45. Control mechanisms 50 may be provided on the cycle 40, such as on the handlebars assembly 48, the steering tube 45 as shown, or on other parts of the frame 42. The control mechanisms 50 may be constructed and arranged to communicate with one or more input receiving or control devices of the cycle 40.

In a number of variations the steering tube 45 may be foldable, which may be effected separately, or in coordination with folding of the frame 42 at the joint 41, and/or the handlebar assembly 48, to place the cycle 40 in a compact package for convenient storage or transportation. The folding system 52 may include one or more joints 41, 53 to fold the cycle 40.

In a number of variations the cycle 40 may include a propulsion system 55 that may operate on manual inputs, motor powered inputs, or a combination thereof. The propulsion system 55 may include a crank assembly 62 which may include a crankshaft 64 that may be connected with a first pedal assembly 66 and a second pedal assembly 70. The first pedal assembly 66 may include a first foot pedal 68, and the second pedal assembly 70 may include a second foot pedal 72. A linked element 71, which may be a sprocket or a pulley or another device for linking with a drive wheel 82, may be operatively connected to the crankshaft 64 for driving a linking member 76. The linking member 76 may be a chain or belt or another link suitable for engaging the linked element 71 and may be operatively connected to a rear linked element 78 which may be operatively connected to a hub 80 of the drive wheel 82 at an axle assembly 83. The drive wheel 82 may be a road wheel in-that it contacts the surface upon which the cycle 40 operates. The linked element 78 may be a sprocket or pulley or another device suitable for engaging with the linking member 76. The cycle 40 may be a bicycle, tricycle, or four-wheel cycle having the crank assembly 62 constructed and arranged to allow a rider to provide input thereto using the first pedal assembly 66 and the second pedal assembly 70, and may include a motor powered unit that may be packaged in the propulsion system 55.

With reference to FIG. 2, the cycle 40 may be reconfigured to a folded position. The joints 41, 51 and 53 may be unlatched to move the cycle from the unfolded position of FIG. 1 to the folded position of FIG. 2. The handlebar assembly 48 may include the pair of opposed handles 63, 65 that may be folded together, the steering tube 45 may be folded alongside the front part 47 of the main tube 44, and the front part 47 may be folded toward the rear part 49 of the main tube 44. The wheels 54 and 82 may be positioned alongside each other, and the axle assemblies 59 and 83 may be aligned. With the cycle 40 folded, it may be conveniently dollied, such as by pulling at the handle 61 with the wheels 54 and 82 trailing behind.

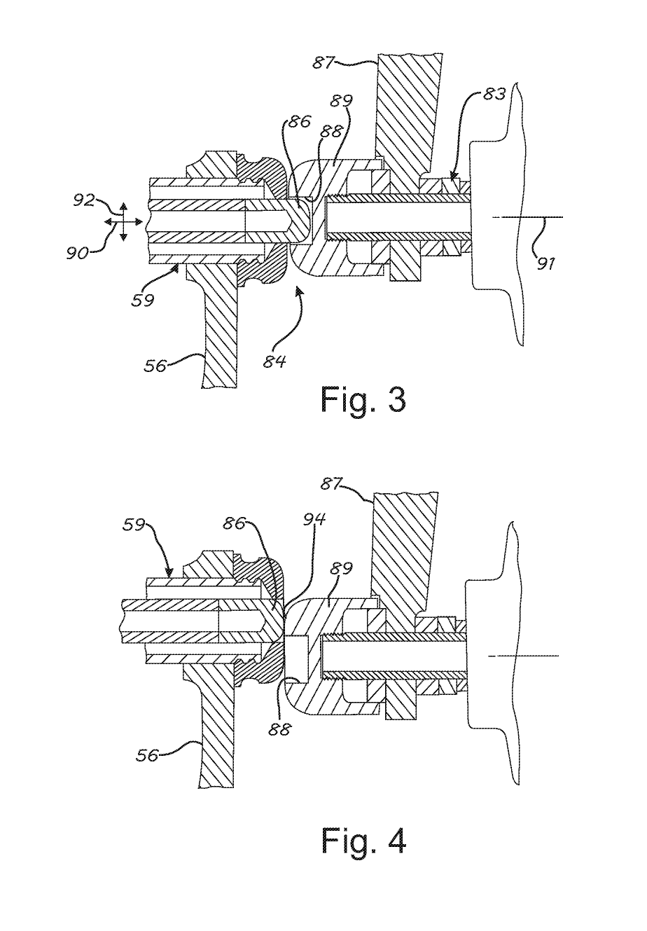

In a number of variations as illustrated in FIG. 3, the wheels 54, 82 may be maintained in an aligned condition when the cycle 40 is folded by a locking system 84. The locking system 84 may include a lock shaft 86 that may be received in a receptacle 88 of a lock receiver 89. In the variation of FIG. 3, the lock shaft 86 may be provided at the axle assembly 59 and the lock receiver 89 may be provided at the axle assembly 83. However, it will be appreciated that the positions of the lock shaft 86 and the lock receiver 89 may be reversed on the two axle assemblies. The lock receiver 89 may thread onto its respective axle assembly laterally outside the fork arm 87, or may otherwise be connected. With the cycle 40 in the folded position of FIG. 2, and the lock shaft 86 in the receptacle 88, the axle assemblies 59, 83 may be maintained in alignment so that the wheels 54, 82 track parallel to one another when dollied, and do not shift relative to one another when the cycle 40 may be carried. The joint 41 may be hinged so that the lock shaft 86 is prevented from moving in a lateral direction 90 out of the receptacle 88. The lock shaft 86 and receptacle 88, when engaged, may prevent the axle assembly 59 from moving in the radial direction 92 relative to the axle assembly 83. It will be understood that the radial direction 92 refers to a direction emanating in any of the three-hundred-sixty degrees around the axis 91 on which the wheels 54, 82 may rotate when the cycle 40 is folded. With reference to FIG. 4, the lock shaft 86 may be loaded, such as with a spring, and may be forced against the load to retract into the axle assembly 59 when engaging the face 94 of the lock receiver 89. This retraction may occur automatically as the frame 42 is folded at the joint 41 while the wheels 54 and 82 swing into alignment. When aligned as shown in FIG. 2, the lock shaft 86 may pop into the receptacle 88.

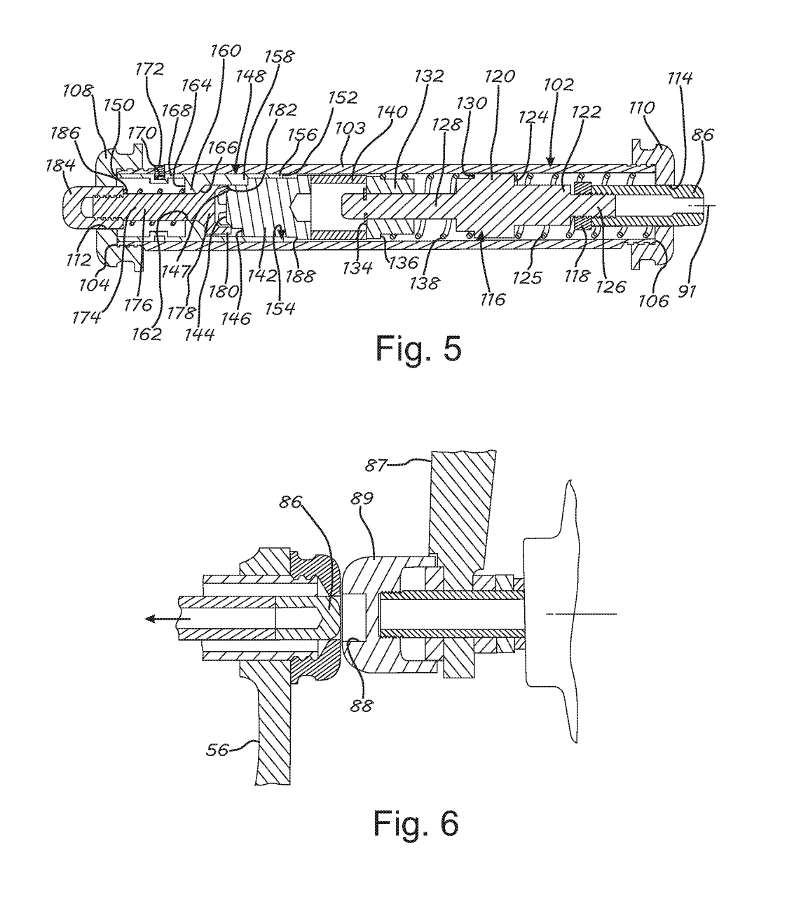

In a number of variations as illustrated in FIG. 5, the lock shaft 86 may be provided in an axle assembly 100, which may be used with the cycle 40 in combination with the lock receiver 89. The axle assembly 100 may include an axle housing 102 that may be of a hollow cylindrical shape with ends 104, 106. The ends 104, 106 may be at least partly closed by respective caps 108, 110, which may be connected with the axle housing 102, such as by threads. Each cap 108, 110 may define an opening 112, 114 respectively, which may open to the inside of the axle housing 102 and which may be aligned with the axis 91. The lock shaft 86 may extend through the opening 114 and may be retractable into the axle housing 102. The lock shaft 86 may be connected to a lock shaft guide 116 that may be positioned inside the axle housing 102 and may translate along the axis 91. A jam nut 118 may secure the lock shaft 86 in position on the lock shaft guide 116. The lock shaft guide 116 may include a segment 120 that may fit closely in the axle housing 102 to slide therein. A segment 122 may have a reduced cross section relative to the segment 120, which may form a step or spring seat 124. The segment 122 may extend from the segment 120 to a segment 126 to which the lock shaft 86 may be connected. A spring 125 may be compressed between the spring seat 124 and the cap 110. The lock shaft guide 116 may include a segment 128 on an opposite side of the segment 120 from the segment 122. The segment 128 may have a cross section of a reduced size relative to the segment 120, and a spring seat 130 may be formed on the segment 120 on an opposite side from the spring seat 124. A spring retainer 132 may be held on the segment 128, such as by a circlip 134 that may be fixed on the segment 128 and may be engaged with the spring retainer 132. The spring retainer 132 may define a spring seat 136 that may face the spring seat 130. A spring 138 may be compressed between the spring seats 130, 136.

In a number of variations a spacer 140 may be positioned adjacent the spring retainer 132. The spacer 140 may be in the shape of a hollow cylinder and may fit closely against the wall 103 of the axle housing 102. The segment 128 of the lock shaft guide 116 may extend completely through the spring retainer 132 and at least partially through the spacer 140. A cam lock 142 may be positioned in the axle housing 102 adjacent the spacer 140. The cam lock 142 may include an end 144 opposite from the spacer 140 that may include at least one slot 146. The slot 146 may extend in the direction of the axis 91 in the cam lock 142. The cam lock 142 may include at least one cam surface 147.

In a number of variations the end 144 of the cam lock 142 may be disposed inside a cam guide insert 148. The cam guide insert 148 may extend from a first end 150 adjacent the cap 108 to a second end 152 positioned over the cam lock 142. The cam guide insert 148 may have a generally hollow cylindrical shape with a stepped interior profile 154, and may fit closely within the axle housing 102 against the wall 103. The profile 154 may have a segment 156 surrounding the cam lock 142. A segment 158 adjacent the segment 156 may surround the end 144 of the cam lock guide 142 and may extend radially in toward the axis 91 further than the segment 158. A segment 160 adjacent the segment 158 may extend radially in toward the axis 91 further than the segment 158 and may form an annular surface 162 facing the axis 91 and forming an opening. The segment 158 may form a surface 164 facing the cap 108 and a surface 166 that extends from the surface 162 to the segment 158 and may be disposed at an acute angle relative to the axis 91 forming a funnel shape. The cam guide insert 148 may include a segment 168 adjacent the segment 160 that may extend toward the cap 108. The segment 168 may be generally of a hollow cylindrical shape and may include a groove 170. A set screw 172 may be threaded through the wall 103 into the groove 170 to fix the cam guide insert 148 in place relative to the axle housing 102.

In a number of variations a cam release 174 may be positioned within the cam guide insert 148 and may extend from the cap 108 to the cam lock 142. The cam release 174 may mate with the funnel shape of the cam guide insert 148. The cam release 174 may include a shaft 176 that may extend through the segment 168 of the cam guide insert 148, and through the opening at the surface 162. The cam release 174 may include a body 178 that may be positioned within the segment 168 of the cam guide insert 148, and that may be connected with the shaft 176. The body 178 may include at least one arm 180, and at least one cam surface 182. The cam surface 182 may engage the cam surface 147 of the cam lock 142 to alternatively move the arm 180 into or out of the slot 146. A release push button 184 may be connected with the shaft 176 and may extend through the opening 112 of the cap 108 and out of the axle housing 102. The release push button 184 may form a release shaft extending through the cap 108. A spring 186 may be positioned around the shaft 176 and may extend from the release push button 184 to the surface 164.

In a number of variations the arm 180 of the cam release 174 may be positioned outside the slot 146 and against the end 144 of the cam lock 142. The spring 186 may apply a force to the release push button 184 pulling the body 178 of the cam release 174 against the surface 166 of the cam guide insert 148. This may maintain the release push button 184 in a position presenting outside the cap 108 when not manually pushed inward. With the arm 180 against the end 144, the cam lock 142 may be positioned with its shoulder 188 spaced away from the second end 152 of the cam guide insert 148. This may move the spacer 140 and the spring retainer 132 to apply an increased compressive force to the spring 138. In response, the spring 138 may apply an increased force to the lock shaft guide 116 compressing the spring 125 and moving the lock shaft 86 out of the opening 114 in the cap 110 presenting the lock shaft 86 in a lock shaft engaged position of FIG. 5. This prepares the lock shaft 86 for automatic engagement with the lock receiver 89, with the lock shaft 86 loaded by the spring 138.

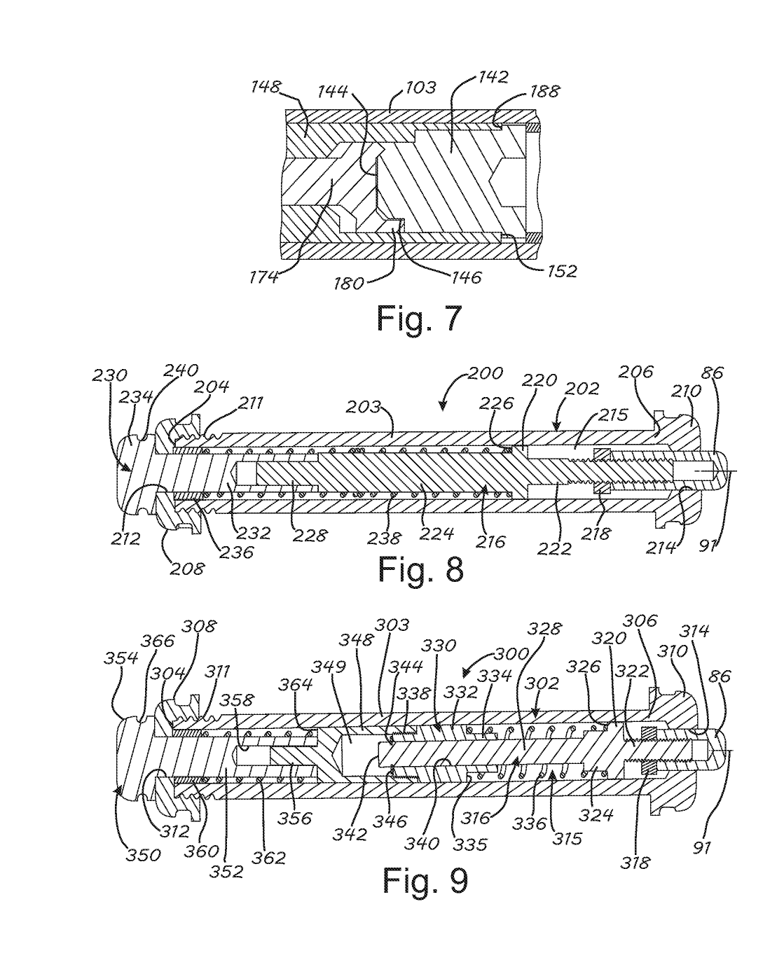

In a number of variations, to unfold the cycle 40, the lock shaft 86 may be disengaged from the lock receiver 89 to a lock shaft disengaged position of FIG. 6. The release push button 184 may be depressed pushing the cam release 174 whereby its cam surface 182 may act against the cam surface 147 of the cam lock 142 to index the cam lock 142 so that the arm 180 may engage into the slot 146 as shown in FIG. 7. The moves the cam lock 142 so that its shoulder 188 moves against the second end 152 of the cam guide insert 148. This allows the spacer 140 and the spring retainer 132 to move toward the cap 108 following the cam lock 142 and reducing the compressive force applied to the spring 138. This allows the spring 125 to move the lock shaft guide 116 against the spring 138 pulling the lock shaft 86 into the opening 114 to the lock shaft disengaged position of FIG. 6. This allows the axle assemblies 59, 83 to swing relative to one another so that the joint 41 may be closed and the frame 44 unfolded to the position of FIG. 1. To prepare the lock shaft 86 for engagement with the lock receiver 89, the release push button 184 may be pushed so that the cam surfaces 182, 147 index the cam lock 142 to disengage the arm 180 from the slot 146 so that the lock shaft 86 is against presented to the lock shaft engaged position of FIG. 5.

In a number of variations as illustrated in FIG. 8, the lock shaft 86 may be provided in an axle assembly 200, which may be used in combination with the lock receiver 89, such as in the cycle 40. The axle assembly 200 may include an axle housing 202 that may be of a hollow cylindrical shape with a wall 203 and ends 204, 206. The ends 204, 206 may be at least partly closed by respective caps 208, 210, which may be connected with the axle housing 202, such as by threads 211, or may be integrally formed therewith, such as the cap 210. Each cap 208, 210 may define an opening 212, 214 respectively, which may open to the interior 215 of the axle housing 202 and which may be aligned with the axis 91. The lock shaft 86 may extend through the opening 214 and may be retractable into the axle housing 202. The lock shaft 86 may be connected to a lock shaft guide 216 that may be positioned in the interior 215 of the axle housing 202, and may translate along the axis 91. A jam nut 218 may secure the lock shaft 86 in position on the lock shaft guide 216. The lock shaft guide 216 may include a segment 220 that may fit closely in the axle housing 202 to slide therein against the wall 203. A segment 222 may have a reduced cross section relative to the segment 220. The lock shaft 86 may be connected to the segment 222. The lock shaft guide 216 may include a segment 224 on an opposite side of the segment 220 from the segment 222. The segment 224 may have a cross section of a reduced size relative to the segment 220, and a spring seat 226 may be formed on the segment 220 on an opposite side from the segment 222. The lock shaft guide 216 may have a segment 228 adjacent the segment 224 and on an opposite side thereof from the segment 220. The segment 228 may have a cross section of a reduced size relative to the segment 224. A release shaft 230 may extend through the opening 212 in the cap 208 and may include a shaft 232 and a connected knob 234. The shaft 232 may overlie, and may be connected with, the segment 228 of the lock shaft guide 216. The knob 228 may be presented outside the axle housing 202 at the end 204 opposite the lock shaft 86. A spacer 236 may be in the shape of a ring and may be positioned around the shaft 232 at the end 204 of the axle housing 202. A spring 238 may be positioned around the shaft 232 and around the segment 224, and may extend in the axle housing 202 from the spacer 236 to the spring seat 226. The spring 238 may apply a force to pull the knob 234 against the cap 208 to present the lock shaft 86 outside the axle housing 202 to a lock shaft engaged position of FIG. 8. To move the lock shaft 86 to the lock shaft disengaged position of FIG. 6, the knob 234 may be manually grasped and pulled to retract the lock shaft 86 in through the opening 214 and into the axle housing 202. The knob 234 may include an annular groove 240 to assist with gripping. When the manual grasp is released from the knob 234, the spring 238 returns the lock shaft 86 to the lock shaft engaged position of FIG. 8 ready for automatic engagement with the lock receiver 89.

In a number of variations as illustrated in FIG. 9, the lock shaft 86 may be provided in an axle assembly 300, which may be used in combination with the lock receiver 89, such as in the cycle 40. The axle assembly 300 may include an axle housing 302 that may be of a hollow cylindrical shape with a wall 303 and ends 304, 306. The ends 304, 306 may be at least partly closed by respective caps 308, 310, which may be connected with the axle housing 302, such as by threads 311, or may be integrally formed therewith, such as the cap 310 at end 306. Each cap 308, 310 may define an opening 312, 314 respectively, which may open to the interior 315 of the axle housing 302 and which may be aligned with the axis 91. The lock shaft 86 may extend through the opening 314 and may be retractable into the axle housing 302. The lock shaft 86 may be connected to a lock shaft guide 316 that may be positioned in the interior 315 of the axle housing 302, and may translate along the axis 91. A jam nut 318 may secure the lock shaft 86 in position on the lock shaft guide 316. The lock shaft guide 316 may include a segment 320 that may fit closely in the axle housing 302 to slide therein against the wall 303. A segment 322 may have a reduced cross section relative to the segment 320. The lock shaft 86 may be connected to the segment 322. The lock shaft guide 316 may include a segment 324 on an opposite side of the segment 320 from the segment 322. The segment 324 may have a cross section of a reduced size relative to the segment 320, and a spring seat 326 may be formed on the segment 320 on an opposite side from the segment 322. The lock shaft guide 316 may have a segment 328 adjacent the segment 324 and on an opposite side thereof from the segment 320. The segment 328 may have a cross section of a reduced size relative to the segment 324.

In a number of variations the segment 328 of the lock shaft guide 316 may extend through a guide cap 330. The guide cap 330 may have a segment 332 that may fit closely in the axle housing 302 to slide therein against the wall 303. A segment 334, adjacent the segment 332, may have a cross section of a reduced size relative to the segment 332 forming a spring seat 335. A spring 336 may be compressed between the spring seat 335 and the spring seat 326. A segment 338 of the lock shaft guide 316 adjacent the segment 332 and on an opposite side thereof from the segment 334, may have a cross section of a reduced size relative to the segment 334. The guide cap 330 may have an opening 340 aligned with the axis 91 through which the segment 328 may completely extend. An end 342 of the segment 328 may project out of the opening 340. The segment 328 may include a groove 344 into which a circlip 346 may be positioned to maintain the end 342 outside the opening 340.

In a number of variations a guide housing 348 may be disposed in the axle housing 302 and may overlie, and may be connected to the segment 338 of the guide cap 330. The guide housing 348 may include a cavity 349 into which the end 342 of the lock shaft guide 316 may extend. A release shaft 350 may extend through the opening 312 in the cap 308 and may include a shaft 352 and a connected knob 354. The shaft 352 may form a release shaft extending through the cap 308. The shaft 352 may overlie, and may be connected with, a segment 356 of the guide housing 348. The segment 356 may extend into an opening 358 of the shaft 352 and may be fixed therein. The knob 354 may be presented outside the axle housing 302 at the end 304 opposite the lock shaft 86. A spacer 360 may be in the shape of a ring and may be positioned around the shaft 352 at the end 304 of the axle housing 302. A spring 362 may be positioned around the shaft 352 and the segment 356 and may extend in the axle housing 302 from the spacer 360 to a spring seat 364 on the guide housing 348. The spring 362 may apply a force to pull the knob 354 against the cap 308 to present the lock shaft 86 outside the axle housing 302 under the force of the spring 336, to a lock shaft engaged position of FIG. 9. To move the lock shaft 86 to the lock shaft disengaged position of FIG. 6, the knob 354 may be manually grasped and pulled to retract the lock shaft 86 in through the opening 314 and into the axle housing 302. The knob 354 may include an annular groove 366 to assist with gripping. The guide housing 348, the guide cap 330, the lock shaft guide 316 and the lock shaft 86 may move with the release shaft 350 compressing the springs 362. The circlip 346 may ensure the lock shaft guide 316 moves with the guide cap 330 as the knob 354 is pulled outward away from the cap 308. When the manual grasp is released from the knob 354, the spring 362 may pull the knob 354 against the cap 308 and the spring 336 may return the lock shaft 86 to the lock shaft engaged position of FIG. 9, ready for automatic engagement with the lock receiver 89. When the lock shaft 86 engages the lock receiver 89 as shown in FIG. 4, pushing the lock shaft into the axle housing 302, the lock shaft guide 316 may compress the spring 336 and the segment 328 may slide within the opening 340 with the circlip 346 separating from the segment 338. This may position the end 342 further into the cavity 348 as the lock shaft 86 is pushed into the opening 314. The spring 362 may apply a greater force than the spring 336. As a result, the knob 354 may remain positioned against the cap 308 as the lock shaft 86 moves for automatic engagement with the lock receiver 89.

Through the variations described above, an axle locking system is provided to maintain the front and rear axles of a foldable cycle 40 in alignment, when folded. A lock shaft 86 may engage in a receptacle 88 of a lock receiver 89 when the axles are brought into alignment when the cycle 40 is folded. Engagement may be effected automatically. To release the lock shaft 86 from the lock receiver 89, the axle locking system may include a release push button 184 or a release pull knob 234, 354. As a result, the folded cycle 40 may be securely and confidently carried or dollied, such as, in either case, by using the handle 61. The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may involve a product that may include a first axle assembly that may have a lock shaft extendable from the first axle assembly. The lock shaft may be retractable into the first axle assembly. A second axle assembly may have a lock receiver into which the lock shaft may extend when the first and second axle assemblies may be aligned adjacent to one another.

Variation 2 may include the product according to variation 1 wherein the first axle assembly may include an axle housing that may have a first end and a second end. A first cap may be located on the first end through which the lock shaft may extend.

Variation 3 may include the product according to variation 2 and may include a second cap on the second end through which a release shaft may extends. The release shaft may be engaged with the lock shaft through the first axle assembly and may be movable to reposition the lock shaft between a lock shaft engaged position where the lock shaft may be engaged in the lock receiver and a lock shaft disengaged position where the lock shaft may be disengaged from the lock receiver.

Variation 4 may include the product according to variation 3 wherein the release shaft may include a push button that when pushed into the axle housing may reposition the lock shaft.

Variation 5 may include the product according to variation 3 and may include a knob that may be connected to the release shaft and that when pulled away from the second cap, may reposition the lock shaft.

Variation 6 may include the product according to variation 3 and may include a cam release and a cam lock through which the release shaft may be engaged with the lock shaft. The cam release may include a first cam surface and an arm. The cam lock may include a second cam surface and a slot. The first and second cam surfaces may engage one another to move the arm into or out of the slot to move the lock shaft between the engaged position and the disengaged position.

Variation 7 may include the product according to variation 3 and may include a lock shaft guide that may be engaged between the release shaft and the lock shaft. The lock shaft guide may include a first segment that may be fit against the axle housing to slide therein. The lock shaft guide may include a second section that may have a reduced cross section compared to the first segment. A spring may be included through which the second segment may extend. The spring may be engaged against the first section and may apply a force thereto to load the lock shaft toward the lock shaft engaged position.

Variation 8 may include the product according to variation 1 and may include a cycle with a frame supported on first and second wheels. The first wheel may rotate around the first axle assembly and the second wheel may rotate around the second axle assembly.

Variation 9 may include the product according to variation 8 and may include a joint in the frame that when open may allow the frame to fold so that the first and second axle assemblies may be aligned on a common axis.

Variation 10 may include the product according to variation 9, and may include a handle on the frame for moving the cycle with the first and second wheels locked in an aligned position by engagement of the lock shaft in the lock receiver.

Variation 11 may involve a product that may include a first wheel that may be rotatable on a first axle assembly. A second wheel may be rotatable on a second axle assembly. A lock shaft may be extendable from the first axle assembly and may be retractable into the first axle assembly. A second axle assembly may have a lock receiver into which the lock shaft may extend to lock the first and second axle assemblies in alignment.

Variation 12 may include the product according to variation 11 wherein the first axle assembly may include an axle housing that may have a first end and a second end. A first cap may be located on the first end through which the lock shaft may extend.

Variation 13 may include the product according to variation 12 and may include a second cap on the second end through which a release shaft may extends. The release shaft may be engaged with the lock shaft through the first axle assembly and may be movable to reposition the lock shaft between a lock shaft engaged position where the lock shaft may be engaged in the lock receiver and a lock shaft disengaged position where the lock shaft may be disengaged from the lock receiver.

Variation 14 may include the product according to variation 13 wherein the release shaft may include a push button that when pushed into the axle housing may reposition the lock shaft.

Variation 15 may include the product according to variation 13 and may include a knob that may be connected to the release shaft and that when pulled away from the second cap, may reposition the lock shaft.

Variation 16 may include the product according to variation 13 and may include a cam release and a cam lock through which the release shaft may be engaged with the lock shaft. The cam release may include a first cam surface and an arm. The cam lock may include a second cam surface and a slot. The first and second cam surfaces may engage one another to move the arm into or out of the slot to move the lock shaft between the engaged position and the disengaged position.

Variation 17 may include the product according to variation 13 and may include a lock shaft guide that may be engaged between the release shaft and the lock shaft. The lock shaft guide may include a first segment that may be fit against the axle housing to slide therein. The lock shaft guide may include a second section that may have a reduced cross section compared to the first segment. A spring may be included through which the second segment may extend. The spring may be engaged against the first section and may apply a force thereto to load the lock shaft toward the lock shaft engaged position.

Variation 18 may include the product according to variation 11 and may include a cycle with a frame supported on first and second wheels. The first wheel may rotate around the first axle assembly and the second wheel may rotate around the second axle assembly.

Variation 19 may include the product according to variation 18 and may include a joint in the frame that when open may allow the frame to fold so that the first and second axle assemblies may be aligned on a common axis.

Variation 20 may include the product according to variation 19, and may include a handle on the frame for moving the cycle with the first and second wheels locked in an aligned position by engagement of the lock shaft in the lock receiver.

The above description of select variations within the scope of the invention is merely illustrative in nature and, thus, variations or variants thereof are not to be regarded as a departure from the spirit and scope of the invention.

1. A product comprising a first axle assembly that has a lock shaft extendable from the first axle assembly and retractable into the first axle assembly, a second axle assembly that has a lock receiver into which the lock shaft extends when the first and second axle assemblies are aligned adjacent to one another, wherein the first axle assembly comprises an axle housing that has a first end and a second end, a first cap on the first end through which the lock shaft extends, a second cap on the second end through which a release shaft extends, and the release shaft engaged with the lock shaft through the first axle assembly and movable to reposition the lock shaft between a lock shaft engaged position where the lock shaft is engaged in the lock receiver and a lock shaft disengaged position where the lock shaft is disengaged from the lock receiver.

2. (canceled)

3. (canceled)

4. The product according to claim 1 wherein the release shaft includes a push button that when pushed into the axle housing repositions the lock shaft.

5. The product according to claim 1 comprising a knob that is connected to the release shaft and that when pulled away from the second cap, repositions the lock shaft.

6. The product according to claim 1 comprising a cam release and a cam lock through which the release shaft is engaged with the lock shaft, the cam release including a first cam surface and an arm and the cam lock including a second cam surface and a slot, the first and second cam surfaces engaging one another to move the arm into or out of the slot to move the lock shaft between the engaged position and the disengaged position.

7. The product according to claim 1 comprising a lock shaft guide engaged between the release shaft and the lock shaft, the lock shaft guide including a first segment fit against the axle housing to slide therein, and including a second segment that has a reduced cross section compared to the first segment, and comprising a spring through which the second segment extends, the spring engaged against the first segment applying a force thereto to load the lock shaft toward the lock shaft engaged position.

8. The product according to claim 1 comprising a cycle with a frame supported on first and second wheels, the first wheel rotating around the first axle assembly and the second wheel rotating around the second axle assembly.

9. The product according to claim 8 comprising a joint in the frame that when open allows the frame to fold so that the first and second axle assemblies are aligned on a common axis.

10. The product according to claim 9, comprising a handle on the frame for moving the cycle with the first and second wheels locked in an aligned position by engagement of the lock shaft in the lock receiver.

11. A product comprising a first wheel rotating on a first axle assembly, a second wheel rotatable on a second axle assembly, a lock shaft extendable from the first axle assembly and retractable into the first axle assembly, a second axle assembly that has a lock receiver into which the lock shaft extends to lock the first and second axle assemblies in alignment, wherein the first axle assembly includes an axle housing that has a first end and a second end, a first cap on the first end through which the lock shaft extends, a second cap on the second end through which a release shaft extends, and the release shaft engaged with the lock shaft through the first axle assembly and movable to reposition the lock shaft between a lock shaft engaged position where the lock shaft is engaged in the lock receiver and a lock shaft disengaged position where the lock shaft is disengaged from the lock receiver.

12. (canceled)

13. (canceled)

14. The product according to claim 11 wherein the release shaft includes a push button that when pushed into the axle housing repositions the lock shaft.

15. The product according to claim 11 comprising a knob that is connected to the release shaft and that when pulled away from the second cap, repositions the lock shaft.

16. The product according to claim 11 comprising a cam release and a cam lock through which the release shaft is engaged with the lock shaft, the cam release including a first cam surface and an arm and the cam lock including a second cam surface and a slot, the first and second cam surfaces engaging one another to move the arm into or out of the slot to move the lock shaft between the engaged position and the disengaged position.

17. The product according to claim 11 comprising a lock shaft guide engaged between the release shaft and the lock shaft, the lock shaft guide including a first segment fit against the axle housing to slide therein, and including a second segment that has a reduced cross section compared to the first segment, and comprising a spring through which the second segment extends, the spring engaged against the first segment applying a force thereto to load the lock shaft toward the lock shaft engaged position.

18. The product according to claim 11 comprising a cycle with a frame connected to the first and second wheels.

19. The product according to claim 18 comprising a joint in the frame that when open allows the frame to fold so that the first and second axle assemblies are positionable to an aligned position on a common axis.

20. The product according to claim 19, comprising a handle on the frame for moving the cycle with the first and second wheels locked in the aligned position by engagement of the lock shaft in the lock receiver.
